(19) United States
(12) Patent Application Publication
(10) Pub. No.: US 2009/0283166 A1
(43) Pub. Date: Nov. 19, 2009

(54) Transmission solenoid adapter

(75) Inventor: David E. Gott, Walnut Grove, MO (US)

Correspondence Address: LATHROP & GAGE LLP, 1845 S. NATIONAL, P.O. BOX 4288, SPRINGFIELD, MO, 65808-4288, US

(73) Assignee: DNJ Components, LLC

(21) Appl. No.: 12/454,497

(22) Filed: May 19, 2009

Related U.S. Application Data
(60) Provisional application No. 61/128,176, filed on May 19, 2008.

(51) Int. Cl. F16K 11/14; F16K 27/00

(52) U.S. Cl. 137/862; 248/231.9

(57) ABSTRACT

The present invention is an adapter for mounting a replacement solenoid to a Chrysler, Dodge or Jeep transmission manufactured between 1993 and 2007. The adapter includes a manifold with a transverse mounting block that allows a replacement solenoid to be mounted substantially parallel to the transmission casing. A plurality of pressurized fluid passages are in fluid communication with the replacement solenoid and a factory transducer to the transmission. This adapter allows reliable aftermarket solenoid manufactured by third parties to be retrofitted on to certain Chrysler, Dodge and Jeep transmission known to have high solenoid failure rates.

### RELATED APPLICATION

This Application claims the priority of the provisional patent application Ser. No. 61/128,176 filed May 19, 2008, and incorporates the disclosure of the referenced application herein.

The present invention relates to a solenoid adapter for use on an automatic transmission for a vehicle. More particularly, the solenoid adapter allows a variety of aftermarket solenoids to be adapted for use on certain automatic vehicle transmissions manufactured by or for Chrysler Corporation and specifically used on Chrysler, Dodge and Jeep transmissions manufactured between 1993 and 2007.

### DESCRIPTION OF RELATED ART

The shifting and fluid pressure regulation of the modern automatic transmission is controlled by fluid control devices commonly called solenoids, pressure regulation solenoids called force motor solenoids and pressure switches. Such devices supply and regulate the flow of transmission fluid to perform various functions of the automatic transmission. Solenoids are devices consisting of an electrical coil which, upon a specific amount or range of electrical current flowing through it, activates a valve to control the flow of transmission fluid. A transmission solenoid is an electro-hydraulic valve that controls fluid flow into and throughout an automatic transmission. Solenoids can be normally open or normally closed. They operate via a voltage or current supplied via the transmission computer or controller. Transmission solenoids are usually installed in a transmission valve body, transmission control unit, or transmission control module. A defective solenoid causes an automatic transmission to malfunction and often results in inappropriate shifting, shift failure or overall transmission failure.

When a solenoid becomes defective, the normal cause is an obstruction to fluid flow in the solenoid valve from fluid contamination, dirt and debris, or because of an open or short-circuit in the solenoid coil. Numerous devices exist to determine whether a solenoid is defective. Solenoid failure can be determined utilizing test apparatus while the solenoid is in place on the transmission or after being removed.

Mechanics, specifically including those familiar with automatic transmissions, are well aware of a problem with the solenoids provided on certain transmissions manufactured by or for Chrysler Motor Company. Specifically, transmissions exhibiting high solenoid failure are found on several models of Chrysler, Dodge or Jeep transmissions manufactured between 1993 and 2007.

Replacement or aftermarket solenoids provided by Chrysler Corporation are generally available for these specific transmissions of interest. The replacement solenoids, however, have an abnormally high rate of failure. It is not uncommon for replacement solenoids to have 50-75% failure rate out of the box.

It is therefore desirable to exchange the problematic solenoids with solenoids of different manufacture known to have lower failure rates. There are various aftermarket solenoid manufacturers that provide readily available replacement solenoids with very low failure rates. It is important to have low solenoid failure rates out of the box because these parts are typically not covered by any warranty and defective solenoids are typically thrown away with the customer being charged for each such defective solenoid.

Unfortunately, the aftermarket solenoids with low failure rates are not readily adaptable for use on Chrysler or Jeep transmissions. At the present, there are no known devices which allow the retrofit of any solenoid to a Chrysler, Dodge or Jeep transmission which is manufactured by competitive companies or other aftermarket providers. What is needed is an adapter which allows a solenoid manufactured by AC Delco or others to be quickly and easily coupled to transmissions on vehicles within the Chrysler family of autos.

### BACKGROUND OF THE INVENTION

It is therefore desirable to have an adapter block which allows an aftermarket solenoid manufactured by a third party to be adapted and retrofitted to a Chrysler, Dodge or Jeep transmission known to have solenoid failure problems. Specifically, certain automatic transmissions utilized on Chrysler and Jeep products between 1993 and 2007 have solenoid failure problems. These specifically include transmission models 42RE, 44RE, 46RE, 47RE, and 48 RE.

There are any number of manufacturers that produce solenoid having fluid capacity and electrical capacity compatible with the identified Chrysler and Jeep transmissions. These include the following listed solenoids:

1993-2002 Transmissions
Transtar Model 34435A/5D-152A
AC Delco 24220158
Allomatic TH700 solo 1
Tim's Transmission 34605U
Sentinel Model SW2814AC
Delta 35399A
Aceomatic Model 16231
Borg Warner 50058

For Chrysler transmissions manufactured in 2003 and later, the appropriate solenoid replacements are:
Transtar Model 34435B/5D-152B
Borg Warner 50058
AC Delco 24230632
Allomatic 4L60E solo 6

None of the identified replacement solenoids, however, are immediately compatible for retrofit to these transmissions of interest. The Chrysler manufactured solenoids typically mount to the transmission at a receptacle which orients the solenoid substantially perpendicular to the transmission casing. A simple electrical plug provides power to the solenoid. Because the replacement solenoids are not compatible with the Chrysler solenoid receptacle, an adapter is required. Simple adapters which would allow the replacement solenoid to be plugged directly in to the transmission receptacle are unusable because of limited clearance between the transmission casing and the vehicle frame and body. Therefore, to fit a replacement solenoid manufactured by companies other than Chrysler on to the Chrysler transmission requires the solenoid to be installed generally parallel, rather than perpendicular, to the transmission casing. Because the solenoid is in fluid communication with the transmission, orienting the solenoid parallel rather than perpendicular creates an obstacle particular to transmission fluid control. The instant invention overcomes that obstacle.

### SUMMARY OF THE INVENTION

It is therefore a general object of the present invention to provide a solenoid adapter which specifically comprises a manifold adaptable for retrofitting onto a Chrysler, Dodge or Jeep manufactured transmission for the retrofit of a third-party aftermarket solenoid. According to the present invention, a manifold block is provided which is immediately compatible with the identified Chrysler transmissions. The block has formed transmission fluid channels, including specifically a governor pressure channel and a forward clutch channel. Transmission fluid passes through each of these channels and regulated by the solenoid. Because the solenoid cannot be mounted perpendicular to the transmission and achieve the required clearance, a solenoid transverse mounting block is provided which is substantially perpendicular to the manifold. The solenoid itself then is fastened to the transverse mounting block which is in fluid communication with both the governor pressure channel and forward clutch channel. The solenoid is mounted perpendicular to the mounting block and is parallel the transmission.

The replacement solenoids identified above all have electrical tolerances compatible with the factory Chrysler solenoids. Accordingly, it is unnecessary to alter the resistance to ground and the replacement solenoid can be wired directly to the factory provided electrical circuitry. It is preferable to provide an adapter plug to fit between the replacement solenoid and the transmission wiring to avoid the necessity of splicing the electrical wires.

The solenoid manifold is also configured to allow use of the factory provided transducer which is mounted on the manifold near the solenoid. The solenoid allows selective engagement of either the governor pressure channel or the forward clutch channel which is regulated by both the automatic transmission fluid pressure present in the transmission and the predefined electrical capacity of the transducer. The retrofitted solenoid operates in the same manner as the Chrysler, Dodge or Jeep manufactured solenoid. This allows the aftermarket solenoids to be quickly and readily mounted to the Chrysler, Dodge or Jeep manufactured transmissions and because of the efficiency of the replacement solenoids minimizes the necessity of solenoid replacements over the life of the transmission.

The above and other objects, features and advantages of the present invention will become more apparent from the following description when taken in conjunction with the accompanying drawings in which a preferred embodiment of the present invention is shown.

### BRIEF DESCRIPTION OF THE DRAWINGS

FIG. 1 is a view of the exterior of a transmission.

FIG. 2 is a view of an original equipment solenoid attached to the transmission.

FIG. 3 is a plan view of the exterior of the inventive solenoid adapter.

FIG. 4 is a view of the inventive solenoid adapter attached to a transmission.

FIG. 5 is a plan view of the interior of the inventive solenoid adapter showing transmission fluid channels.

### DETAILED DESCRIPTION OF THE INVENTION

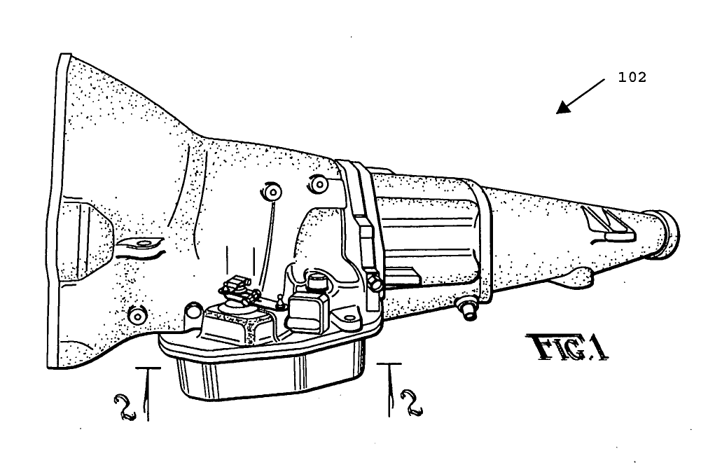

Referring now to FIG. 1, a transmission 104 is shown with axis 2-2 showing the location of the solenoid and the solenoid adapter. The solenoid and the solenoid adapter are located internally in the transmission.

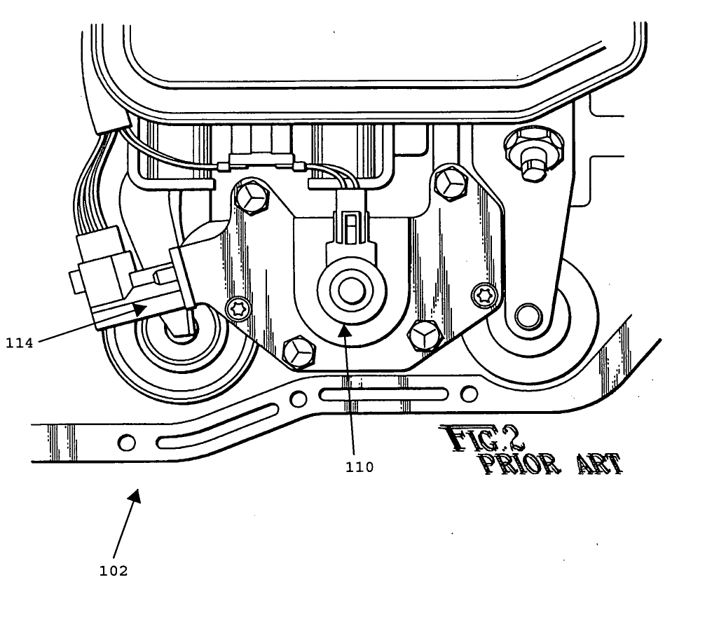

Referring now to FIG. 2, an original equipment solenoid is shown attached to the transmission 104.

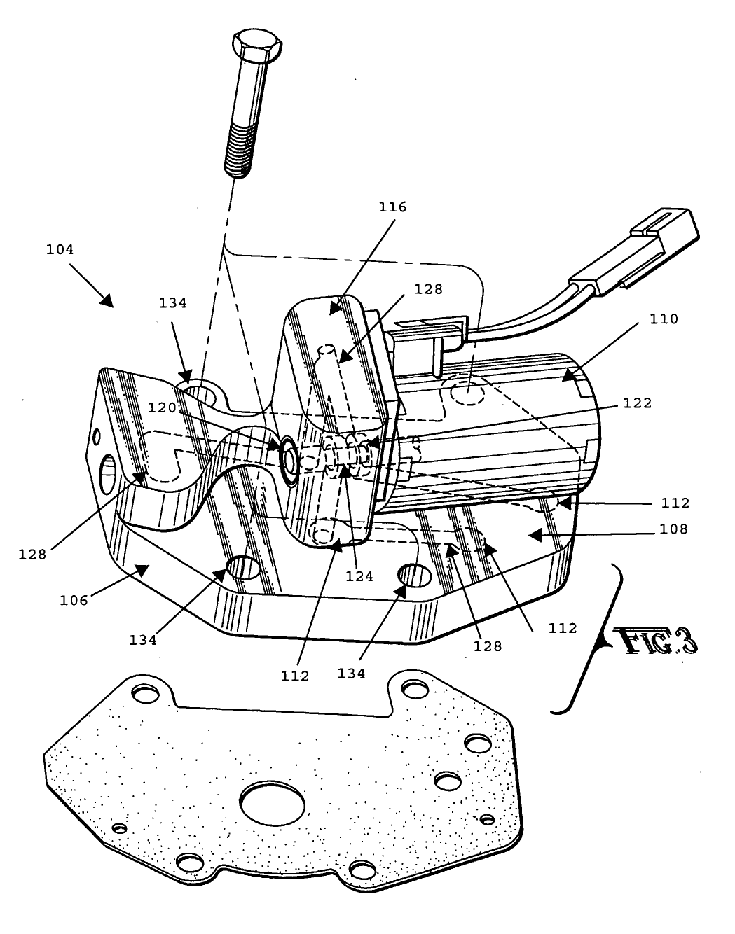

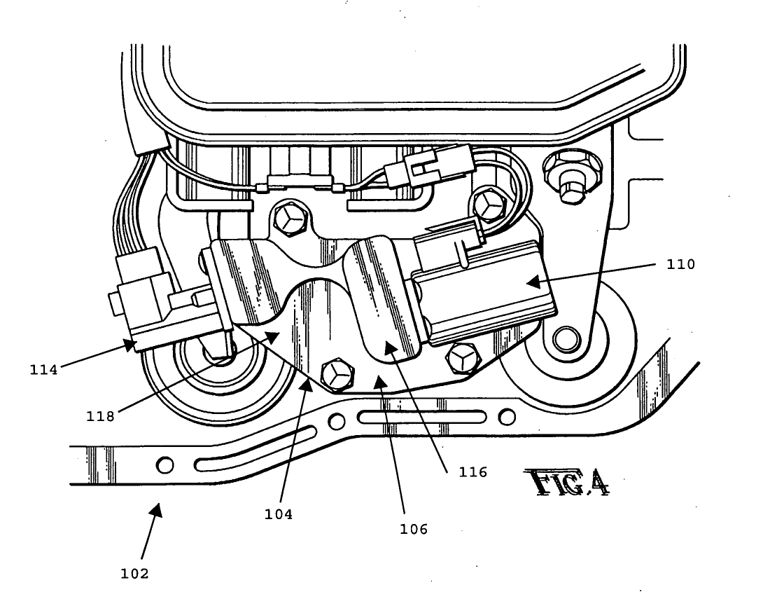

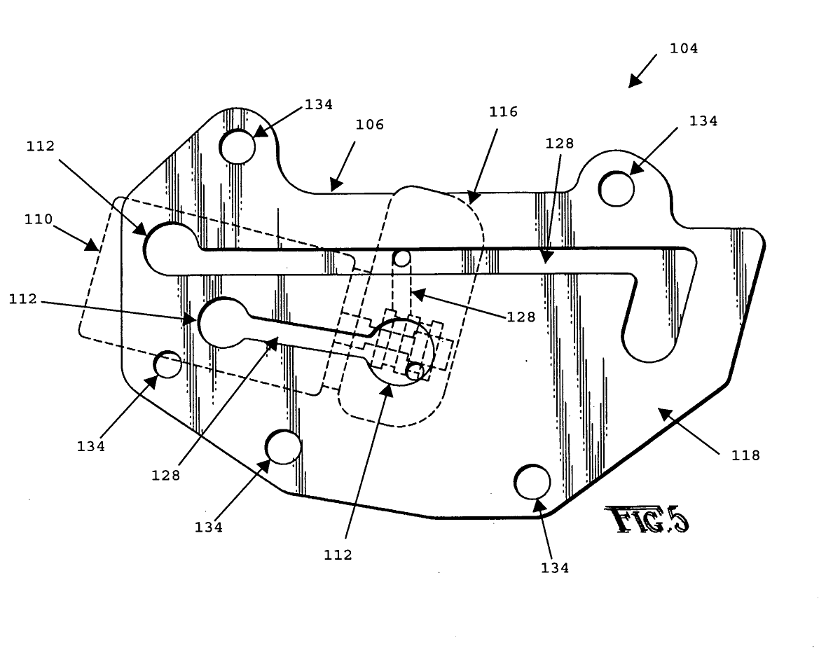

Referring now generally to FIGS. 3, 4 and 5, a transmission 102 is generally shown with an aftermarket solenoid adapter manifold 104 according to an embodiment of the present invention is shown. The manifold 104 comprises a body 106 having a solenoid connecting bore 120 further into which a plurality of ports 112 of a solenoid operated valve are connected, a transducer 114 and a transverse solenoid mounting block 116. The manifold 104 has an outer side 108 and inner surface 118. The automatic transmission fluid ports 112 are positioned on the inner surface 118 of the manifold and in fluid communication through the manifold to both the transducer 114 and solenoid 110. At least a governor pressure circuit 134 and forward clutch circuit 136 are provided on the inner surface 118. A transverse solenoid mounting block 116 is mounted substantially perpendicular to the manifold 104 on the outer surface 108 at the solenoid bore 120 or opening. A solenoid opening 122 is formed in the transverse block 116 such that the solenoid 110 itself is fastened substantially parallel to the manifold 104 at connections provided by the manufacturer of the solenoid 110. When the manifold 104 is fastened to the transmission 102, the solenoid lies substantially parallel the transmission case. The solenoid 110 is electronically operated through the standard provided electrical connections with the vehicle. A plug which is compatible with the factory vehicle electrical connector for the transmission solenoid will be provided with the solenoid adapter manifold such that solenoids from other manufacturers can be wired to the plug for easy connection to the vehicle electrical connector.

In one embodiment, a manifold 104 is connected to a solenoid operating valve 124 which comprises a body 126 having a plurality of fluid passages 128, a port mount 130 for receiving a port member 132 for supplying and discharging a fluid under pressure to and from the solenoid operated valve 124. The port mount 130 is defined by a connection surface of the body 126 to which the solenoid operated valve 124 is directly connected. An engaging mechanism is mounted to the body 126 substantially parallel to the connection surface of the body. Upon the engaging mechanism being displaced into engagement with the port mount 130 the solenoid operated valve 124 is locked on the body 126 through the port mount 130 with conventional fasteners or fastening means.

Another description of the solenoid adapter is: a device having a body 106 with a plurality of passages 118 formed throughout in a conventional manner. An internally threaded portion or receptacle 120 is provided for mounting a transverse mounting block 116 into which the after market solenoid 110 is fastened. An externally threaded adapter portion may also be provided for engaging the manifold to the adapter portion. An axial passage through the transverse mounting block 116 communicates with the passage of the body 106 to allow flow of pressurized fluid from the manifold 104 to the solenoid 110. There are also a plurality of ports 112 in fluid communication with the body 106 and the solenoid 110 for selective flow of pressurized fluid between the solenoid 110 and the manifold 104. A plurality of mounting bores 134 are oriented through the manifold for fastening it directly to the transmission shell.

A plurality of mounting holes 134 are formed transversely through the manifold 104 and are alignable with the factory provided mounting holes on specific transmissions manufactured and used on Chrysler-manufactured transmissions used in Chrysler, Dodge and Jeep vehicles. Specifically, the mounting holes 134 in the manifold block are compatible with those found on Chrysler, Dodge and Jeep transmission models 42RE, 44RE, 46RE, 47RE, and 48 RE manufactured between 1993 and 2007. This allows the manifold 104 to be bolted directly to the transmission 102 without modification to the transmission itself. The transmissions intended for use with the inventive adapter include model numbers 42RE, 44RE, 46RE, 47RE, and 48 RE and are manufactured by or for Chrysler Corporation for use in Chrysler and Jeep vehicles. There are many manufacturers that produce solenoid having fluid capacity and electrical capacity compatible with the identified Chrysler and Jeep transmissions.

For transmissions manufactured in 1993-2002, appropriate replacement solenoids include:
Transtar Model 34435A/5D-152A
AC Delco 24220158
Allomatic TH700 solo 1
Tim's Transmission 34605U
Sentinel Model SW2814AC
Delta 35399A
Aceomatic Model 16231
Borg Warner 50058

For transmissions manufactured in 2003 and later, the appropriate solenoid replacements are:
Transtar Model 34435B/5D-152B
Borg Warner 50058
AC Delco 24230632
Allomatic 4L60E solo 6

Although certain preferred embodiments of the present invention have been shown and described in detail, it should be understood that various changes and modifications may be made therein with departing from the scope of the appended claims.

What is claimed is:

1. An adapter for connecting an aftermarket solenoid onto a Chrysler-manufactured transmission, comprising: a manifold having a plurality of mounting bores alignable with the mounting bores of the transmission; a transverse solenoid mounting block for orienting a replacement solenoid substantially parallel the manifold; a transducer; a plurality of fluid ports and fluid channels operably connecting the solenoid and the transducer to receiving ports and channels on the transmission.

2. The adapter of claim 1 further comprising an electrical plug for electrically connecting the replacement solenoid to the transmission.

3. The adapter of claim 1 wherein the mounting bores and the plurality of ports and channels are configured to operably mate with transmission manufactured between 1993 and 2007 for Chrysler and Jeep vehicles.

4. The adapter of claim 3 wherein the adapter is configured to specifically mate to Chrysler, Dodge and Jeep transmissions selected from the group consisting of model numbers 42RE, 44RE, 46RE, 47RE, and 48 RE.

5. A manifold connected to a solenoid operating valve, comprising: a body having a plurality of fluid passages defined therein; a port mount for receiving a port member for supplying and discharging a fluid under pressure to and from the solenoid operated valve, said port mount provided on an outer surface of the body to which the solenoid operated valve is connected; an engaging mechanism mounted to the body and mounted substantially parallel to the connection surface of the body and upon the engaging mechanism being displaced into engagement with the port member the solenoid operated valve is locked on the body through the port member.

6. An adapter for installing a replacement transmission solenoid comprising a body having a plurality of passages therethrough, an internally threaded portion for engaging the solenoid and an externally threaded adapter portion for engaging the manifold, wherein the adapter portion includes at least one axial passage in fluid communication with at least one passage of the body for flow of pressurized fluid from the manifold to the solenoid; a plurality of ports communicating with the passages of the body for flow of pressurized fluid from the solenoid through the manifold and a plurality of mounting bores for fastening the manifold to a transmission.

7. The adapter of claim 6 further comprising a transverse mounting block position substantially perpendicular to the manifold body and further having a receptacle for a replacement solenoid with a fluid passage between the solenoid and manifold body such that the solenoid is mounted to the transverse block substantially parallel the manifold.

8. The adapter of claim 1 wherein the replacement solenoid is selected from a group of replacement solenoids consisting of:
Transtar Model 34435A/5D-152A
AC Delco 24220158
Allomatic TH700 solo 1
Tim's transmission 34605U
Sentinel Model SW2814AC
Delta 35399A
Aceomatic Model 16231
Borg Warner 50058
Transtar Model 34435B/5D-152B
Borg Warner 50058
AC Delco 24230632
Allomatic 4L60E solo 6.
